(19) United States
(12) Patent Application Publication
(10) Pub. No.: US 2007/0017616 A1
(43) Pub. Date: Jan. 25, 2007

(54) Traction aid for wheeled vehicles

(76) Inventor: Power Abanto, Bergenfield, NJ (US)

Correspondence Address: Power Abanto, 101 West Central Avenue, Bergenfield, NJ, 07621, US

(21) Appl. No.: 11/185,162

(22) Filed: Jul. 21, 2005

(51) Int. Cl. B60C 27/00

(52) U.S. Cl. 152/187; 152/188

(57) ABSTRACT

A traction aid for wheeled vehicles cooperable with the circumferential peripheral grooves of a tire of the wheeled vehicle, the traction aid comprising a cable securable at both ends, forming a loop, fixedly secured to the cable, there being a plurality of beads such that when installed, the cable lies completely recessed within a respective circumferential peripheral groove of the tire and the respective beads extend outwardly and above the upper surface of the tread of the tire thereby providing additional traction and grip in cooperation with the cross grooves of the tire in snowy and icy climatic conditions.

### BACKGROUND OF THE INVENTION

1. Field of the Invention

The present invention relates to a traction aid for wheeled vehicles for use in snow and ice conditions, the traction aid cooperable with and positioned in the circumferential grooves of the respective tires mounted on the respective drive wheels of the vehicle.

2. Description of the Prior Art

Obtaining traction for a wheeled vehicle in snow and ice conditions has been a problem since the early development of the automobile. One solution to the problem was to change out the road tires on the drive wheels as winter approached and replace those tires with what are commonly referred to as snow tires, these tires having a significant tread difference than the normal road tires in order to provide better traction in snow and ice conditions. In some instances, and in some climates, snow tires in and of themselves were insufficient to provide the necessary traction and grip.

A supplementary solution to the snow tire solution was the development of tire chains, which consisted of a chain mesh wrapped around the circumferential surface of the tires and held in place by a tensioning force (see U.S. Pat. Nos. 6,536,491; 4,799,522; and 4,922,982). This solution proved satisfactory when the climatic conditions required this extreme measure. However, in the absence of snow and ice on the road surface, the chains proved noisy and because of the higher speeds on the road surface, absent snow or ice, the chains were likely to become disengaged and become a flying object doing damage to the underside of the vehicle in which they were mounted, or a trailing vehicle. Because of this danger, the tire chains would have to be removed as soon as the roadways were clear.

Another development which attempted to address the solution of added traction and grip in snow and icy climatic conditions was the development of the studded snow tire. This was essentially a snow tire having a significant tread differentiation from that of the normal road tire, but in which was embedded tungsten studs which protruded radially outwardly from the circumferential peripheral surface and which were designed to penetrate packed snow or ice as the wheel and tire revolved in order to provide traction. These worked in certain instances, but it soon became evident that when no snow or icy climatic conditions were prevalent on the paved roadways, the tungsten studs damaged the roadway and prematurely degraded the surface of the roadway, hence, studded snow tires with the outwardly extending tungsten studs were outlawed in many jurisdictions.

Applicant's invention is directed to improving the traction and grip of a wheeled vehicle in snow and icy climatic conditions, which is easily installed and cooperable with the circumferential periphery of the tire of the wheeled vehicle, provides necessary traction and grip, does not damage the roadway surface, and does not have to be removed during short intervals of non-snow or non-ice climatic conditions.

### OBJECTS OF THE INVENTION

An object of the present invention is to provide for a novel traction device for a wheeled vehicle which improves traction in snow and icy climatic conditions.

Another object of the present invention is to provide for a novel traction device for a wheeled vehicle which is cooperable with and removably embedded in the circumferential peripheral grooves of the tire.

Another object of the present invention is to provide for a novel traction device for snow and icy climatic conditions in which a cable having beads formed therein is embedded in the circumferential grooves of the tire such that the beads secured on the cable extend above the outermost level of the tread of the tire.

Another object of the present invention is to provide for a novel traction device for a wheeled vehicle in which the ends of each respective cable are easily secured with a tensioning device.

A still further object of the present invention is to provide for a novel traction device for a wheeled vehicle in which the beads positioned on the cable are dimensioned so as to not inflict unwanted wear and tear or damage to a clear road surface.

A still further object of the present invention is to provide for a novel traction device for a wheeled vehicle in which the traction device can remain mounted on the tire during intervals of non-snowy and icy climatic conditions.

### SUMMARY OF THE INVENTION

A traction aid for wheeled vehicles cooperable with the circumferential peripheral grooves of a tire of the wheeled vehicle, the traction aid comprising a cable securable at both ends, forming a loop, fixedly secured to the cable, there being a plurality of beads such that when installed, the cable lies completely recessed within a respective circumferential peripheral groove of the tire and the respective beads extend outwardly and above the upper surface of the tread of the tire thereby providing additional traction and grip in cooperation with the cross grooves of the tire in snowy and icy climatic conditions.

### BRIEF DESCRIPTION OF THE DRAWINGS

These and other objects of the present invention will become apparent, particularly when taken in light of the following illustrations wherein:

FIG. 1 is a perspective view of a tire having the traction aid of the present invention installed thereon;

FIG. 2 is a side view of a tire having a traction aid of the present invention installed thereon;

FIG. 3 is a front view of a tire having a traction aid of the present invention installed thereon;

FIG. 4 is a cross section view along plane A-A of FIG. 3 illustrating the traction aid of the present invention;

FIG. 5 is a cross section view along plane B-B of FIG. 3 illustrating the traction aid of the present invention;

FIG. 6 is a partial perspective view of a portion of the traction aid of the present invention;

FIG. 7 is a side cutaway view of a bead member and method of fastening same; and

FIG. 8 is a side cutaway view of a bead member and method of securing the loop of a flexible cable.

### DETAILED DESCRIPTION OF THE INVENTION

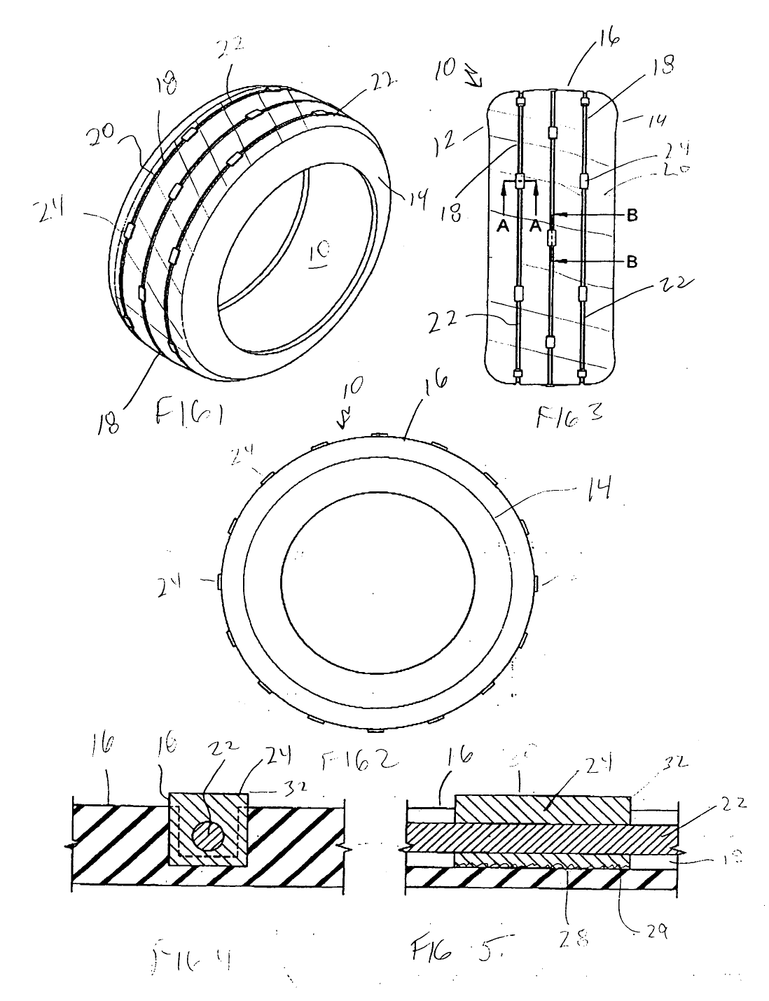

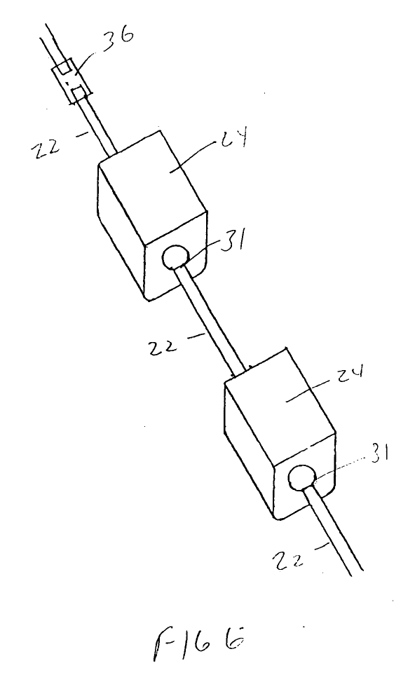

FIG. 1 is a perspective view of a tire having a traction aid of the present invention installed thereon; FIG. 2 is a side view of the tire having a traction aid of the present invention installed thereon; and FIG. 3 is a front view of a tire having a traction aid of the present invention installed thereon.

Tire 10 is a standard pneumatic inflatable tire mountable on a rim (not shown) and mounted on the hub of a vehicle. Tire 10 is composed of opposing side walls 12 and 14 and a circumferential tread surface 16. Tread surface 16 comprises a plurality of circumferential grooves 18 with a plurality of cross grooves 20 either in perpendicular or angular relationship with the circumferential grooves, circumferential grooves and cross grooves thereby defining the tread surface of the tire 10.

Applicant's traction aid is cooperable with the circumferential grooves 18 about tire 10. Applicant's traction aid comprises a flexible cable 22 dimensioned to span the circumference of the tire 10 within circumferential groove 18. The diameter of flexible cable 22 is such that it is fully recessed within the circumferential groove 18 of tire 10. As discussed in more detail hereafter, the ends of the flexible cable 22 are secured together by a suitable fastening means to maintain the flexible cable 22 within a circumferential groove of tire 10.

Fixedly positioned onto flexible cable 22 are a plurality of bead members 24. Bead members 24 are formed with a cable receiving bore 25 and are dimensioned to fit snugly within the circumferential groove 18 of tire 10. They are fixed in position on flexible cable 22 which passes through bore 25 such that they do not slide and they are dimensioned such that their upper surface extends above the tread surface of circumferential surface 16 of tire 10.

FIGS. 1 and 2 illustrate a tire 10 in which there is formed three circumferential grooves 18 about a circumferential tread surface 16. The traction aid in the form of the flexible cable 22 and the plurality of bead members 24 secured thereon are positioned in each of the circumferential grooves 18. As illustrated in FIGS. 1 and 2, the traction aids are installed preferably so that the bead members 24 are not laterally aligned, but rather are offset from each adjacent groove in order to improve traction.

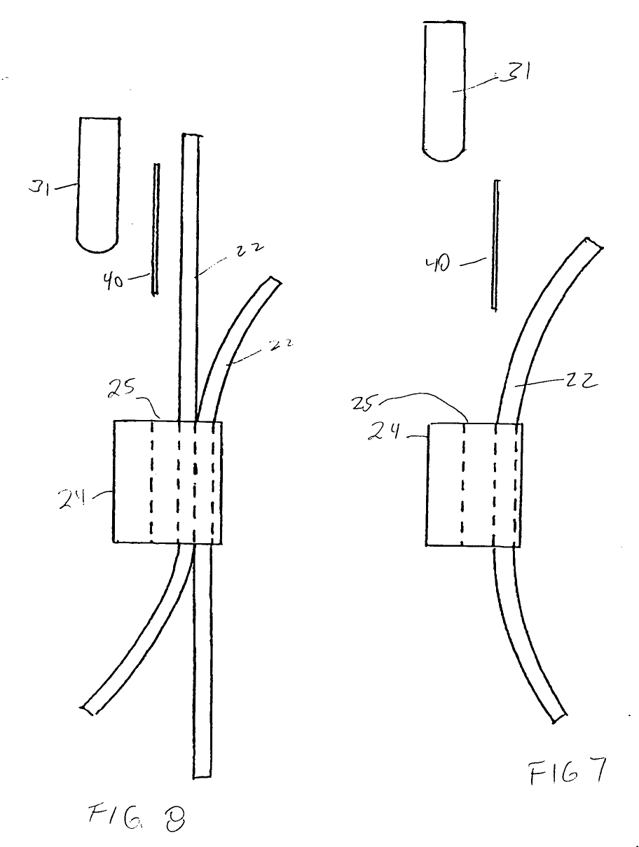

FIG. 4 is a cross sectional view along plane A-A of FIG. 3 illustrating the traction aid of the present invention; FIG. 5 is a cross sectional view along plane B-B of FIG. 3 illustrating the traction aid of the present invention; and FIG. 6 is a partial perspective view of a portion of the traction aid of the present invention.

FIG. 4 is a cross sectional view along plane A-A of FIG. 3 illustrating the circumferential tread surface 16, and a circumferential groove 18 in the tire surface 16. Flexible cable 22 is shown recessed within the circumferential groove 18 in the tread surface 16 and having secured thereto, a bead member 24, with a cable receiving bore 25, which is wedged or snugly secured within the circumferential groove 18 and maintained in position by the tension on the flexible cable 22. FIG. 5 is a cross sectional view of a bead member and cable 24 and 22 positioned in a circumferential groove 18 of tire 10. In this illustration it can be seen that flexible cable 22 is recessed below the upper surface of circumferential tread surface 16 of tire 10. Bead member 24 has its lower surface 28 in communication with the bottom of circumferential groove 18. The upper surface 30 of bead member 24 extends slightly above the circumferential surface 16 of tire 10 thereby defining a protruded portion 32 of bead member 24 extending above the tire surface. This protruded portion 32 of bead member 24 provides additional traction for the wheel in snow and ice conditions due to the fact that whether the vehicle is in a forward or reverse direction, the leading edges of protruded portion 32 which extend above the circumferential tread surface 16 of tire 10 can engage the ice or snow for additional traction and grip.

FIG. 6 illustrates a perspective view of a portion of the traction aid illustrating one manner in which the ends of the flexible cable 22 can be secured by a crimp cable connector 36 so as to provide sufficient tension on the flexible cable 22 to maintain the traction aid in position in the circumferential groove 18 of tire 10. FIG. 6 also illustrates one manner in which the bead members 24 can be secured to flexible cable 22. One means is that flexible cable 22 and bead member 24 are secured directly by means of a possible weld 31. In this configuration receiving bore 25 would be dimensioned to the cross section of flexible cable 22 to facilitate the weld.

In an alternative manner, a wedge 31 is slid into receiving bore 25 to frictionally secure the bead position on the flexible cable 22 as illustrated in FIG. 7. Bead member 24 has been slidably positioned on flexible cable 22 to its desired location, the wedge 31 is pressure fit into receiving bore 25 so as to cause a friction lock between bead member 24, wedge 31 and the flexible cable 22, thereby maintaining the bead member at the desired location on flexible cable 22. The receiving bore 25 in this configuration is greater than the circumference of flexible cable 22 in order to accommodate wedge 31. Still further, as an alternative means for securing flexible cable 22 in a loop about tire 10, one of the bead members 24 on each of the flexible cables 22 could serve as the fastening means by having a receiving bore large enough to accept both ends of the flexible cable 22 as illustrated in FIG. 8. Wedge 31 is illustrated as being cylindrical, however other geometric shapes may suffice. When the bead member 24 is secured to flexible cable 22 in the manner illustrated in FIGS. 7 and 8, a steel spacer strip 40 may be utilized to protect flexible cable 22 while wedge 31 is pressure inserted.

Flexible cable member 22 would preferably be constructed of steel and may be coated. The bead members 24 would preferably be formed of steel and fixedly secured to flexible cable 22 at desired intervals. Bead members 24 may further have their lower surface 28 textured 29 to increase the grip of the bead member within the circumferential groove 18 of the tire 10.

FIGS. 1 and 2 illustrate a tire with three circumferential grooves 18 and three traction aids, one traction aid secured within each groove. Certain tires may be constructed with more than three circumferential grooves, and it would be a matter of choice as to whether or not to secure a traction aid in each and every circumferential groove 18 about a tire 10. Indeed in extreme conditions, it may be advisable that each circumferential groove be fitted with a traction aid. In some instances, it may suffice that not all of the circumferential grooves be fitted with a traction aid of the present invention. For instance, in the tire 10 illustrated in FIGS. 1 and 2, it may suffice that a traction aid only be positioned in the outer circumferential grooves 18 of tire 10 and still achieve the desired traction and grip for the snow or icy climatic condition.

The traction aid would preferably be installed on tire 10 when tire 10 is deflated or partially deflated. The securing means would secure the two ends of the cable and then the tire would be inflated which would create the firm and rigid mounting of the traction aid to the tire 10 within circumferential groove 18.

While the present invention has been described with respect to the exemplary embodiments thereof, it will be recognized by those of ordinary skill in the art that many modifications or changes can be achieved without departing from the spirit and scope of the invention. Therefore it is manifestly intended that the invention be limited only by the scope of the claims and the equivalence thereof.

I claim:

1. A traction aid for wheeled vehicles for use in snow and ice conditions comprising:
a vehicle wheel having a pneumatic tire mounted thereon, said pneumatic tire having a plurality of circumferential grooves in a tread surface;
a plurality of flexible cables, each having a first end and a second end, each flexible cable circumscribing said circumferential groove in said tread surface of said tire forming a loop and a securing means securing said ends of said flexible cable in said loop, said flexible cable having a diameter less than the depth of said circumferential grooves in said tread surface;
a plurality of bead members in spaced apart relationship on said flexible cable and secured in position on said cable, said bead members dimensioned to seat in said circumferential grooves of said tread surface, an upper portion of said bead member extending above said circumferential groove and above said tread surface, said upper portion of said bead member providing additional traction in snow and icy road conditions.

2. The traction aid in accordance with claim 1 wherein said receiving throughbore in said bead member is dimensioned to the circumference of said flexible cable and said bead member and said flexible cable are secured by a spot weld.

3. The traction aid in accordance with claim 1 wherein said receiving throughbore in said bead member is dimensioned greater than said circumference of said flexible cable, said bead member and said flexible cable secured by a wedge member compressibly inserted into said receiving throughbore with said flexible cable.

4. The traction aid in accordance with claim 1 wherein said flexible cable is formed into a loop and secured by a cable crimp.

5. The traction aid in accordance with claim 1 wherein said flexible cable is formed into a loop and secured by a bead member having a receiving throughbore of a size to accommodate said ends of said flexible cable and a wedge member to frictionally secure the ends of said flexible cable in said bead member.

6. The traction aid in accordance with claim 1 wherein a lower groove contacting surface of said bead member is textured to afford better grip with said circumferential groove.

7. The traction aid in accordance with claim 1 wherein said traction aid is positioned and secured within said circumferential groove of said pneumatic tire when said pneumatic tire is in a deflated or partially deflated condition.

8. The traction aid in accordance with claim 7 wherein the inflation of said tire with said traction aid circumscribing said circumferential groove secure said traction aid in said circumferential groove.

9. A traction aid for wheeled vehicles of the type having a pneumatic tire mounted on a wheel, said pneumatic tire having a plurality of circumferential grooves formed in a tread surface, being defined by a bottom surface and opposing side wall surfaces thereby defining the depth of said circumferential groove, said traction aid comprising:
a flexible cable member having a first end and a second end and having a cross sectional circumference less than said depth of said circumferential groove of said tire, said flexible cable member having positioned thereon a plurality of bead members, said bead members having a width which allows seating between said two opposing side walls of said circumferential groove, a bottom wall of said bead member in communication with said bottom of said circumferential groove, said bead member extending upwardly above said side walls of said circumferential groove and said tread surface of said pneumatic tire.
a securing means for securing said ends of said flexible cable in said circumferential groove of said pneumatic tire.

10. The traction aid in accordance with claim 9 wherein said bottom surface of said bead member is textured so as to provide improved seating with said bottom wall of said circumferential groove.

11. The traction aid in accordance with claim 9 wherein a traction aid is associated with one or more circumferential grooves of said pneumatic tire.

12. The traction aid in accordance with claim 9 wherein said receiving throughbore in said bead member is dimensioned to the circumference of said flexible cable and said bead member and said flexible cable are secured by a spot weld.

13. The traction aid in accordance with claim 9 wherein said receiving throughbore in said bead member is dimensioned greater than said circumference of said flexible cable, said bead member and said flexible cable secured by a wedge member compressibly inserted into said receiving throughbore with said flexible cable.

14. The traction aid in accordance with claim 9 wherein said flexible cable is formed into a loop and secured by a cable crimp.

15. The traction aid in accordance with claim 9 wherein said flexible cable is formed into a loop and secured by a bead member having a receiving throughbore of a size to accommodate said ends of said flexible cable and a wedge member to frictionally secure the ends of said flexible cable in said bead member.

16. The traction aid in accordance with claim 9 wherein said traction aid is positioned and secured within said circumferential groove of said pneumatic tire when said pneumatic tire is in a deflated or partially deflated condition.

17. The traction aid in accordance with claim 16 wherein the inflation of said tire with said traction aid circumscribing said circumferential groove secure said traction aid in said circumferential groove.
